(19) United States
(12) Patent Application Publication
(10) Pub. No.: US 2016/0309481 A1
(43) Pub. Date: Oct. 20, 2016

(54) REDUCTION OF CHANNEL ACCESS DELAY IN WIRELESS SYSTEMS

(71) Applicant: QUALCOMM Incorporated, San Diego, CA (US)

(72) Inventors: Lochan Verma, San Diego, CA (US); Olufunmilola Omolade Awoniyi-Oteri, San Diego, CA (US)

(21) Appl. No.: 14/866,475

(22) Filed: Sep. 25, 2015

Related U.S. Application Data
(60) Provisional application No. 62/148,686, filed on Apr. 16, 2015.

(51) Int. Cl. H04W 72/04; H04W 24/08; H04L 29/06

(52) U.S. Cl. CPC H04W 72/0486; H04L 65/1069; H04W 24/08

(57) ABSTRACT

This disclosure describes methods and apparatuses for per-packet frequency and/or per-packet band switching to reduce channel access delay in wireless systems. This disclosure also introduces a transmitting and receiving architecture for per-packet frequency and/or per-packet band switching in single MAC (e.g. a single 802.11 standard amendment) systems and multi-MAC (e.g. multiple 802.11 standard amendment) systems.

This application claims the benefit of U.S. Provisional Application 62/148,686 filed 16 Apr. 2015, the entire content of which is incorporated by reference.

### TECHNICAL FIELD

This disclosure relates to wireless communication.

### BACKGROUND

An ever growing number of devices are being equipped with wireless communication capabilities. The Institute of Electrical and Electronics Engineers (IEEE) has developed a family of standards referred to as the 802.11 standards, which define the communication protocols that are commonly referred to as WiFi. WiFi is commonly used for both peer-to-peer communication and communication across a network. Many devices are also configured to communicate using other communication protocols such as LTE, GSM, EDGE, and others.

### SUMMARY

This disclosure introduces techniques for enabling communication of data between devices using the first available channel, which may require switching, per packet, between two different standards, such as two different 802.11 standards, or between two different configurations of the same standard. The techniques of this disclosure may potentially diversify packet transmissions over different standard amendments/bands/frequencies and reduce per-packet channel access delay. The techniques of this disclosure may be applicable for various wireless networks, such as infrastructure WLAN (wireless local area network), Wi-Fi Direct (P2P), D2D (device to device) in WAN (e.g., LTE (Long Term Evolution)), and others.

In one example, a method for receiving data includes, during a communication session, receiving a first data packet from a device on a first wireless communication channel; during the communication session, receiving a second data packet from the device on the second wireless communication channel; and processing the first data packet and the second data packet.

In another example, a method for transmitting data includes, during a communication session, processing a first data packet and a second data packet; during the communication session, transmitting, with a device, the first data packet from a device on a first wireless communication channel; and during the communication session, transmitting, with the device, the second data packet from the device on a second wireless communication channel.

In another example, a device for receiving data includes a receiver configured to receive, during a communication session, a first data packet from a device on a first wireless communication channel; during the communication session, receive a second data packet from the device on the second wireless communication channel; and one or more processors configured to process the first data packet and the second data packet.

In another example, a device for transmitting data includes one or more processors configured to process a first data packet and a second data packet and a transmitter configured to transmit, during a communication session, transmit the first data packet from a device on a first wireless communication channel, and during the communication session, transmit the second data packet from the device on a second wireless communication channel.

In another example, a computer-readable medium store instructions that when executed by one or more processors causes the one or more processors to receive, during a communication session, a first data packet from a device on a first wireless communication channel, during the communication session, receive a second data packet from the device on the second wireless communication channel, and process the first data packet and the second data packet.

In another example, a computer-readable medium store instructions that when executed by one or more processors causes the one or more processors to process, during a communication session, a first data packet and a second data packet, and during the communication session, transmit, with a device, the first data packet on a first wireless communication channel, and during the communication session, transmit the second data packet on a second wireless communication channel.

In another, an apparatus for receiving data includes means for receiving, during a communication session, a first data packet from a device on a first wireless communication channel; means for receiving, during a communication session, a second data packet from the device on the second wireless communication channel; and means for processing the first data packet and the second data packet.

In another example, an apparatus for transmitting data includes means for processing, during a communication session, a first data packet and a second data packet; means for transmitting, with a device, during the communication session, the first data packet from a device on a first wireless communication channel; and means for transmitting, with the device, during the communication session, the second data packet from the device on a second wireless communication channel.

The details of one or more examples of the disclosure are set forth in the accompanying drawings and the description below. Other features, objects, and advantages of the disclosure will be apparent from the description, drawings, and claims.

### BRIEF DESCRIPTION OF DRAWINGS

FIG. 1 shows an example system of devices configured to implement the techniques of this disclosure.

FIG. 2 shows an example system of devices configured to implement the techniques of this disclosure.

FIG. 3 shows an example of a transmitter design that may be used to implement the techniques of this disclosure.

FIG. 4 shows an example of a transmitter design that may be used to implement the techniques of this disclosure.

FIG. 5 shows an example of a receiver design that may be used to implement the techniques of this disclosure.

FIG. 6 shows an example operation sequence performed by two devices configured to implement the techniques of this disclosure.

FIG. 7 is a block diagram illustrating an example instance of a computing device operating according to techniques described in this disclosure.

FIG. 8 is a block diagram illustrating an example set of devices that form part of a network.

FIG. 9 is a flowchart showing an example method of receiving data according to the techniques of this disclosure.

FIG. 10 is a flowchart showing an example method of transmitting data according to the techniques of this disclosure.

### DETAILED DESCRIPTION

As more devices configured to communicate over WiFi enter the market, WiFi densification becomes an increasing problem. The Wi-Fi attach rate for new laptops and smartphones is close to 100%. Additionally, the IoT (Internet of Things), in which communication capabilities are being implemented into devices not typically configured for communication, is further adding to the densification of Wi-Fi.

The IEEE 802.11 family of standards is a set of media access control (MAC) and physical layer (PHY) specifications that define implementation protocols for wireless local area network (WLAN) computer communication in the 2.4, 3.6, 5, and 60 GHz frequency bands. IEEE802.11 defines polite protocols that operate on the principle of “listen before talk.” The performance, as measured, for example, by station, network throughput, latency, etc., of the 802.11 protocols potentially degrades as the number of devices increases.

Over the years, IEEE802.11 has introduced many amendments for operation of Wi-Fi over different radio frequencies. For example, 802.11af and 802.11ah operate at sub-1 GHz frequencies. The 802.11a/g/n standards operate at 2.4 and 5 GHz frequencies. The 802.11ac standard operates at 5 GHz. The 802.11ad standard operates at 60 GHz frequencies, and the newly emerging 802.11aj standard operates at 45 GHz and 60 GHz. IEEE is already planning the introduction of 802.11ah, 802.11aj, 802.11ax, and 802.11ay in the upcoming years, and in the future, the IEEE 802.11 may continue defining new amendments for operation of Wi-Fi over newly available unlicensed spectrum bands.

Known techniques include executing multiple CSMA/CA state machines in parallel on different pre-negotiated channels. This behavior is currently possible using multi-MAC (media access control) multi-PHY (physical layer) system architecture (e.g., 2.4/5 GHz and 60 GHz SoC). Techniques have been proposed to include per-packet frequency/band switching. However, this behavior is not feasible in current system architectures. For e.g., 802.11 defines channel switch handshake and FST (Fast Session Transfer) handshake, which enable switching frequency/band. Enabling per-packet frequency/band switching leveraging these control handshakes may incur an overhead for every single packet transmission.

This disclosure introduces a new system architecture, which diversifies the Wi-Fi transmissions between two devices over multiple available radio frequencies while still adhering to the “listen before talk” principle. The proposed architecture potentially improves performance by reducing contention on a single radio frequency. This disclosure further describes techniques that potentially address several problems of WiFi systems. This disclosure introduces techniques that potentially address the high efficiency wireless communication problem in densely deployed environments where channel availability may be short and dynamic. If the communicating devices are waiting for the availability of a particular channel, the channel access delay may be so significant to the point of impacting user experience for certain applications especially delay sensitive applications such as video applications, voice communication applications, mirroring applications, etc.

This disclosure introduces techniques for enabling communication of data between devices using the first available channel, which may require switching standard amendments/band/frequency switching per-packet. The techniques of this disclosure may potentially diversify packet transmissions over different standard amendments/bands/frequencies and reduce per-packet channel access delay. The techniques of this disclosure may be applicable for various wireless networks, such as infrastructure WLAN (wireless local area network), Wi-Fi Direct (P2P), D2D (device to device) in WAN (e.g., LTE (Long Term Evolution)), and others.

This disclosure introduces methods and apparatuses for per-packet frequency/band switching and methods and apparatuses to reduce channel access delay in wireless systems. This disclosure also introduces a transmitting (TX) and receiving (RX) architecture for per-packet frequency/band switching in single MAC (e.g. single 802.11 standard amendment) systems, as well as a TX/RX architecture for per-packet frequency/band switching in a multi-MAC (multiple 802.11 standard amendment) systems.

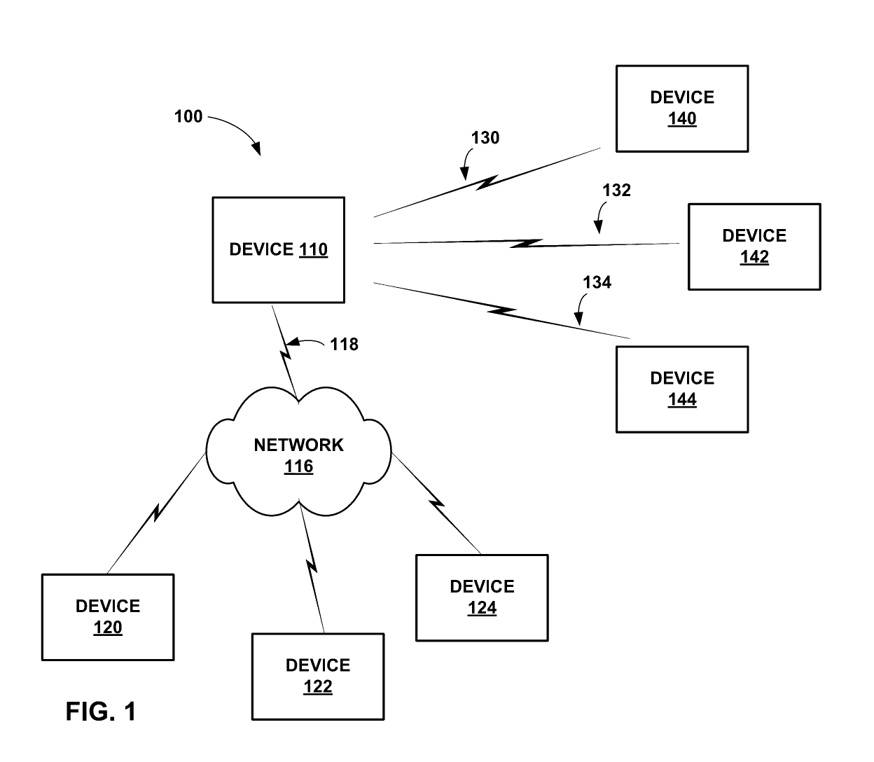

FIG. 1 shows an example system of devices configured to implement the techniques of this disclosure. System 100 includes device 110, network 116, devices 120, 122, and 124, and devices 140, 142, and 144. Device 110 represents any computing device configured for WiFi communication. Device 110 may be a mobile device such as a smartphone or other mobile handset, a tablet computer, a laptop computer, or any other mobile computing devices. Device 110 may also be a larger, more stationary device such as a server, desktop computer, television, set top box, gaming console, or other such device.

Device 110 communicates with devices 120, 122, and 124 via network 116. Device 110 may, for example, wirelessly connect to a network interface device that connects device 110 to network 116 using wireless communication channels 118. Network 116 may, for example, be a local area network (LAN) such as those used in a home or office. In such a configuration, device 110 and devices 120, 122, and 124 may communicate via an access point such as a router. In such a configuration, network 116 may be a wide area network (WAN) such as the internet, in which case network 116 may include an access point to which device 110 connects as well as numerous other devices configured to route data across the network to a destination device. When communicating with an access point of network 116, device 110 may be configured to implement the techniques of this disclosure.

Device 110 also communicates directly with devices 140, 142, and 144 over wireless communication channels 130, 132, and 134, respectively. Device 110 and devices 140, 142, and 144 may be configured to perform peer-to-peer (P2P) communication. Wireless communication channels 130, 132, 134 may comprise any channels capable of propagating communicative signals between device 110 and the respective devices 140, 142, 144. In some examples, the wireless communication channels 118, 130, 132, 134 may be implemented in radio frequency communications in frequency bands such as the 2.4 gigahertz (GHz) band, the 5 GHz band, the 60 GHz band, or other frequency bands. In some examples, the wireless communication channels 118, 130, 132, 134 may comply with one or more sets of standards, protocols, or technologies among Wi-Fi (as promoted by the Wi-Fi Alliance), WiGig (as promoted by the Wireless Gigabit Alliance), and/or the Institute of Electrical and Electronics Engineers (IEEE) 802.11 set of standards (e.g., 802.11, 802.11a, 802.11b, 802.11g, 802.11n, 802.11ac, 802.11ad, etc.), or other standards, protocols, or technologies. The frequency bands used for the wireless communication channels 118, 130, 132, 134, such as the 2.4 GHz, 5 GHz, and 60 GHz bands, may be defined for purposes of this disclosure as they are understood in light of the standards of Wi-Fi, WiGig, any one or more IEEE 802.11 protocols, and/or other applicable standards or protocols, including the Media Agnostic Universal Serial Bus (USB) Draft Specification presently under development. In some examples, the wireless communications channels 130, 132, 134 may represent a single wireless communication channel multiplexed among devices 140, 142, 144.

As will be explained in greater detail below, wireless communication channels 118 may represent a plurality of wireless communication channels utilizing different standards or different configurations of the same standards. Wireless communication channels 130, 132, 134 may likewise each represent a plurality of channels

Device 110 may establish communications with any subset of devices 140, 142, 144 automatically once device 110 and the subset come within operative communication range of each other, or manually in response to a user input, in different examples. Device 110 and devices 140, 142, 144 may use Application Service Platform (ASP) and/or Peripheral Function Protocols (PFPs), such as WiFi Serial Bus (WSB) and Miracast, to manage communications with each other for a variety of services, including a wireless docking service (WDS).

In accordance with the techniques of this disclosure, device 110 may be configured to receive, during a communication session, a first data packet from one of devices 140, 142 or 144 or from an access point of network 116 on a first wireless communication channel, and during the same communication session, also receive a second data packet from the one of devices 140, 142, or 144 or from the access point on network 116 on a second wireless communication channel. Device 110 may also be configured to transmit, during the communication session, a first data packet to one of devices 140, 142 or 144 or an access point of network 116 on a first wireless communication channel, and during the same communication session, also transmit a second data packet to the one of devices 140, 142, or 144 or the access point on network 116 on a second wireless communication channel. As will be explained in greater detail below, the first communication channel and the second communication channel may be defined by a common wireless communication standard or may be defined by different wireless communication standards. The first wireless communication channel and the second wireless communication channel may, for example, utilize different carrier frequencies and/or different modulation schemes.

As will be explained in greater detail below, utilizing techniques of this disclosure, two devices may be enabled to communicate, during a single communication session, using two different standards or the same standard with different transmission parameters. In contrast to existing techniques, which require ending one communication session and establishing a new communication session in order to change the frequency or band being used for communication, the techniques of this disclosure may enable per-packet band switching and per-packet frequency switching without ending one communication session and establishing a new communication session.

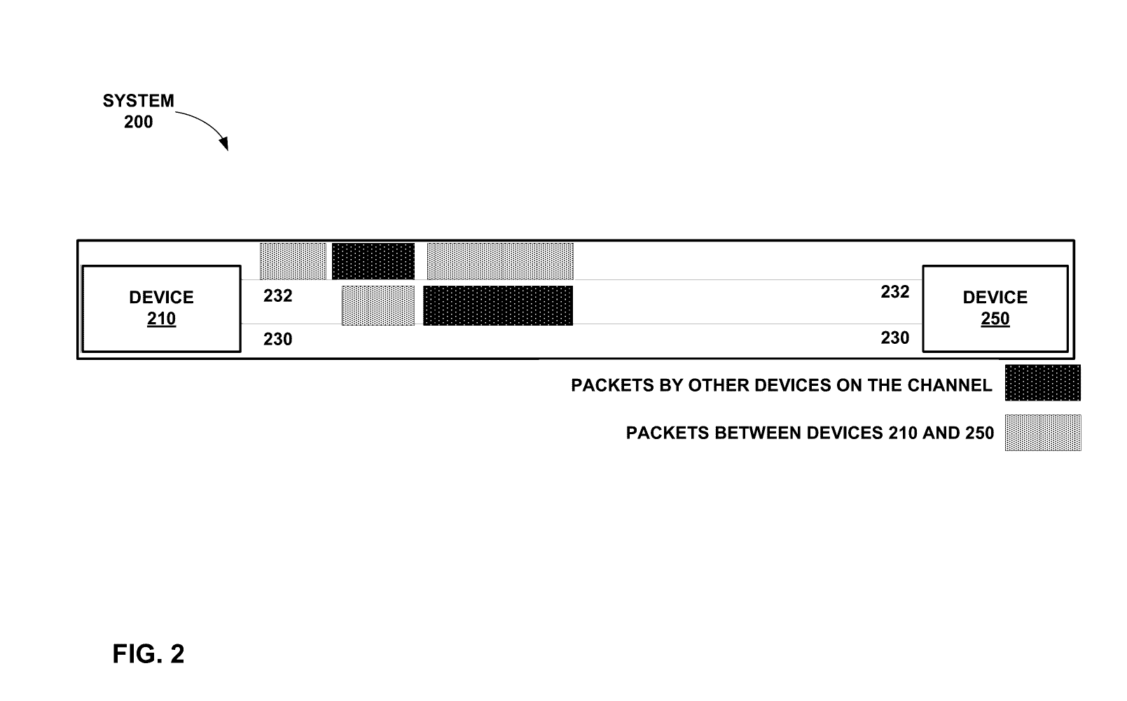

FIG. 2 shows an example system 200 of devices configured to implement the techniques of this disclosure. In the example of FIG. 2, device 210 is configured to communicate with device 250 over communication channel 230 and communication channel 232. Communication channels 230 and 232 also carry packets for other devices. Device 210 may correspond to any of devices 110, 140, 142, and 144 and may be any of a smart phone, tablet, laptop, desktop, television, set top box, gaming console, server, network access, or any other type of device configured for wireless communication. Device 250 may likewise correspond to any of devices 110, 140, 142, and 144 and be any of a smart phone, tablet, laptop, desktop, television, set top box, gaming console, server, network access, or any other type of device configured for wireless communication. In FIG. 2, device 210 is illustrated as transmitting two packets via channel 232 and one packet via channel 230. Device 210 is also shown as transmitting one packet to another device on channel 232 and one packet to another device on channel 230

In one example implementation of the techniques of this disclosure, device 210 and device 250 may communicate using different standards across communication channels 230 and 232. For example, devices 210 and 250 may transmit data using two or more, different 802.11 standard amendments, with communication channels 230 and 232 corresponding to two different channels in the same or different bands. For example, communication channel 230 may be used for communicating according to the 802.11n standard at 2.4 GHz, while communication channel 232 is used for communicating according to the 802.11ac standard at 5 GHz. In another example, communication channel 230 may be used for communicating according to the 802.11b standard at 2.4 GHz, while communication channel 232 is used for communicating according to the 802.11g standard at 2.4 GHz. In another example, instead of using two different 802.11 standards, devices 210 and 250 may communicate using two different versions of the LTE standard.

In another example implementation of the techniques of this disclosure, device 210 and device 250 may communicate using the same standard across communication channels 230 and 232. For example, data transmitted between devices 210 and 250 may be transmitted using the same 802.11 standard amendment, with communication channels 230 and 232 corresponding to two different channels (e.g., carrier frequencies) in the same or different bands. For example, communication channel 230 may be used for communicating according to the 802.11n standard at 2.4 GHz, while communication channel 232 is used for communicating according to the 802.11n standard at 5 GHz. In another example, instead of using an 802.11 standard, devices 210 and 250 may communicate using an LTE standard or other such cellular standard across two different channels.

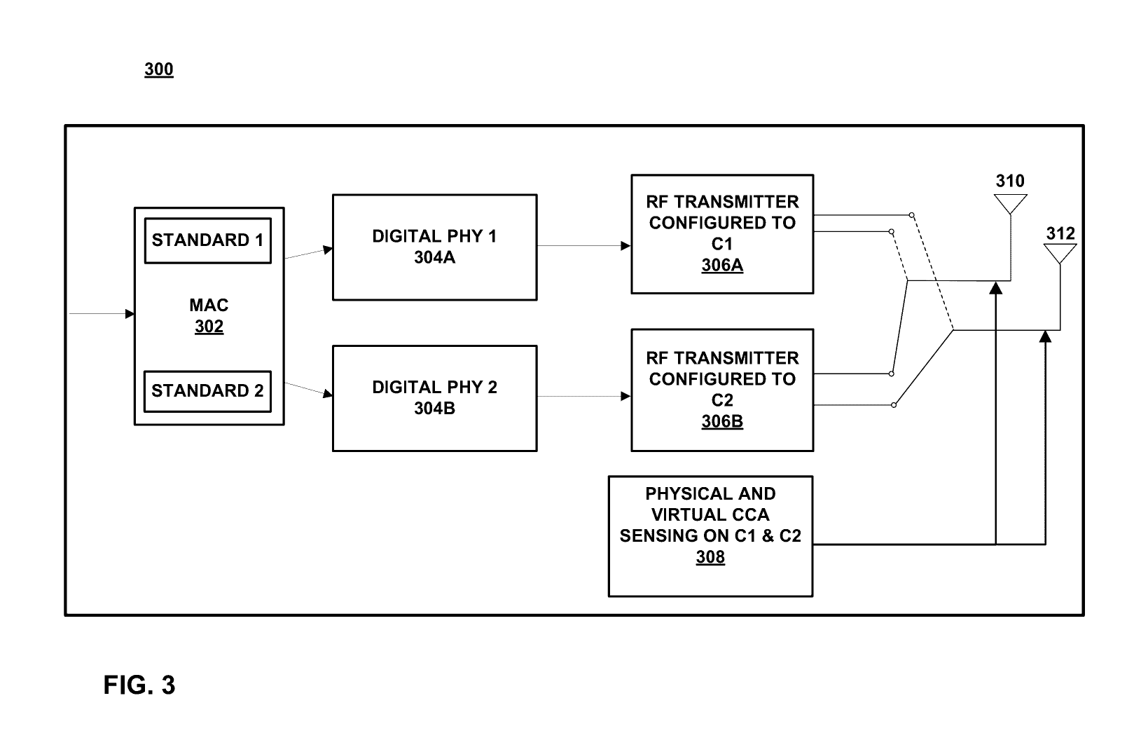

FIG. 3 shows an example of a device configured to transmit data across two or more channels according to different standards, in accordance with the techniques of this disclosure. Device 300 may, for example, correspond to device 210 and/or device 250 described above with respect to FIG. 2. Device 300 may be configured to process, during a communication session, a first data packet and a second data packet, and during the communication session, transmitting the first data packet on a first wireless communication channel and, during the communication session, transmit the second data packet from the device on a second wireless communication channel.

Device 300 includes MAC data communication control module 302 (MAC 302), first digital physical layer hardware 304A (digital PHY 304A), second digital physical layer hardware 304B (digital PHY 304B), an RF transmitter configured to channel 1 306A (RF transmitter 306A), an RF transmitter configured to channel 2 306B (RF transmitter 306B), physical and virtual clear channel assessment (CCA) sensing on channel 1 and channel 2 engine 308 (CCA engine 308), antenna 310, and antenna 312.

In the example of FIG. 3, MAC 302 is configured to generate and assemble datagrams, i.e., data units for transfer, according to two different standards (standard 1 and standard 2). Standards 1 and 2 may, for example, be any of the standards previously described in this disclosure including any of the 802.11 standards or any of the cellular standards previously referenced. Moreover, the techniques of this disclosure are not necessarily limited to any particular group of standards. It is contemplated that the techniques of this disclosure may also be used in conjunction with other standards not explicitly identified herein or with yet-to-be-released standards.

Standards 1 and 2 may define different datagram (e.g. MAC packets) structures, such as different header structures and payload data structures, and may also define different datagram types, such as management frames, control frames, and data frames in IEEE 802.11. In examples where standard 1 and/or standard 2 is an IEEE 802.11 specification, MAC 302 may generate frames with a MAC header and payload data formatted as defined in the particular 802.11 specification. Similarly, if standard 1 and/or standard 2 is an LTE specification, then MAC 302 may generate LTE packets as defined by the LTE specification.

Digital PHY 304A, in conjunction with RF transmitter 306A, converts the datagrams produced by MAC 302 in accordance with standard 1 into a physical signal with the physical characteristics of standard 1, such as the frequency, bandwidth, and supported modulation schemes, that are defined by standard 1. Similarly, digital PHY 304B, in conjunction with RF transmitter 306B, converts the datagrams produced by MAC 302 in accordance with standard 2 into a physical signal with the physical characteristics defined in standard 2, such as the frequency, bandwidth, and supported modulation schemes, that are supported by standard 2. As one example, if standard 1 is the 802.11g protocol and standard 2 is the 802.11n protocol, then digital PHY 304A and RF transmitter 306A may be configured to produce a 2.4 GHz signal with direct-sequence spread spectrum (DSSS) modulation, while digital PHY 304B and RF transmitter 306B may be configured to produce a 5 GHz signal with orthogonal frequency-divisional multiplexing (OFDM) modulation.

In the example above, device 300 includes two separate data paths, which will generally be referred to as the standard 1 path (e.g. MAC 302, digital PHY 1 304A, and RF transmitter 306A) and the standard 2 path (e.g. MAC 302, digital PHY 2 304B, and RF transmitter 306B).

RF transmitters 306A and 306B may implement a variety of functionality, such as filtering of an analog signal to prevent the analog signal from spilling into other channels when transmitted. RF transmitters 306A and 306B may also include power amplifiers for performing signal amplification and modulators for modulating signals to a desired carrier frequency, such as 2.4 GHz, 5 GHz, 45 GHz, 60 GHz, etc.

CCA engine 308 senses the conditions on the two corresponding channels. As part of performing physical sensing, CCA engine 308 may, for example, measure signal strength and/or energy (e.g. RSSI) to determine if a channel is busy. CCA engine 308 may, for example, determine a channel to be “busy” based on a configured threshold referred to herein as the CCA threshold. If the measured energy on a channel is higher than the threshold, then CCA engine 30 may deem the channel to be busy. Otherwise, CCA engine 308 may deem the channel to be “idle.”

As part of performing virtual sensing, CCA engine 308 may, for example, monitor channels 1 and 2 for decoded control packets sent by other users on the channel to indicate if the channel is reserved for a duration of time. If the channel is deemed idle based on both the physical sensing and the virtual sensing for a given duration of time, then CCA engine 308 may identify the channel as usable for transmission. The duration of time may, for example, be determined based on the Wi-Fi defined CSMA procedure.

If the physical sensing of CCA engine 308 indicates that the channel is not busy, and the virtual sensing of CCA engine 308 also indicates that the channel is not being reserved, then device 300 may select that channel to transmit a packet, with the packet being encoded in accordance with the standard corresponding to the selected channel. In instances where multiple channels are determined to be not busy, then CCA engine 308 may be configured to select a data path, i.e. select a standard, based on one or more criteria, such as selecting the data path that produces the highest throughput, selecting the data path the uses minimal power, selecting the data path that gives the lowest latency, or some combination of these criteria.

Device 300 may, for example, during a communication session, process a plurality of data packets in parallel, and CCA engine 308 may measure a physical property of C1 and measure a physical property of C2. Based on the measured physical properties of C1 and C2, CCA engine 308 may select C1 and C2 for transmitting one of the plurality of data packets. CCA engine 308 may also monitor C1 and C2 for control packets to reserve C1 or C2. In response to detecting a control packet to reserve one of C1 or C2, CCA engine 308 may select the other of C1 and C2 for transmitting a data packet. CCA engine 308 may select one of C1 and C2 based on both the physical sensing and the virtual sensing.

In some implementations, device 300 may be configured to simultaneously process packets in accordance with both standards 1 and 2, and then upon CCA engine 308 selecting a channel, only transmit, via one or both of antennas 310 and 312, the packet corresponding to the selected standard. In such an implementation, RF transmitters 306A and 306B may include buffers for holding the packets while awaiting transmission. Upon CCA engine 308 selecting a channel, the RF transmitter of the selected channel may retrieve the packet from the buffer and transmit the packet, while the RF transmitter of the non-selected channel may flush the packet from the buffer, without transmitting the packet. Device 300 is shown in FIG. 3 with two antennas (310 and 312) and with switching circuitry for connecting and disconnecting antennas 310 and 312 from RF transmitters 306A and 306B. Device 300 may, for example, use multiple antennas for purposes such as beamforming and multiplexing in order to improve signal quality and increase bandwidth.

In some implementations, MAC 302 may have an associated buffer for buffering data packets, while RF transmitters 306A and 306B include buffers for buffering control packets to reserve a channel. The control packets may be processed according to the respective standards and buffered at RF transmitters 306A and 306B. Once CCA engine 308 selects a data path, the control packet is transmitted using the selected standard, path and channel and used to reserve the channel. The data packet may also be processed through the channel of the corresponding standard and then transmitted via that channel. Processing the data packets in parallel may reduce delay but may also increase the amount of MAC, PHY, and RF processing associated with transmitting data. Reserving a channel, in contrast, may reduce the amount of MAC, PHY, and RF processing associated with processing data packets in parallel according to two different standards but may not reduce delay as much as performing parallel processing.

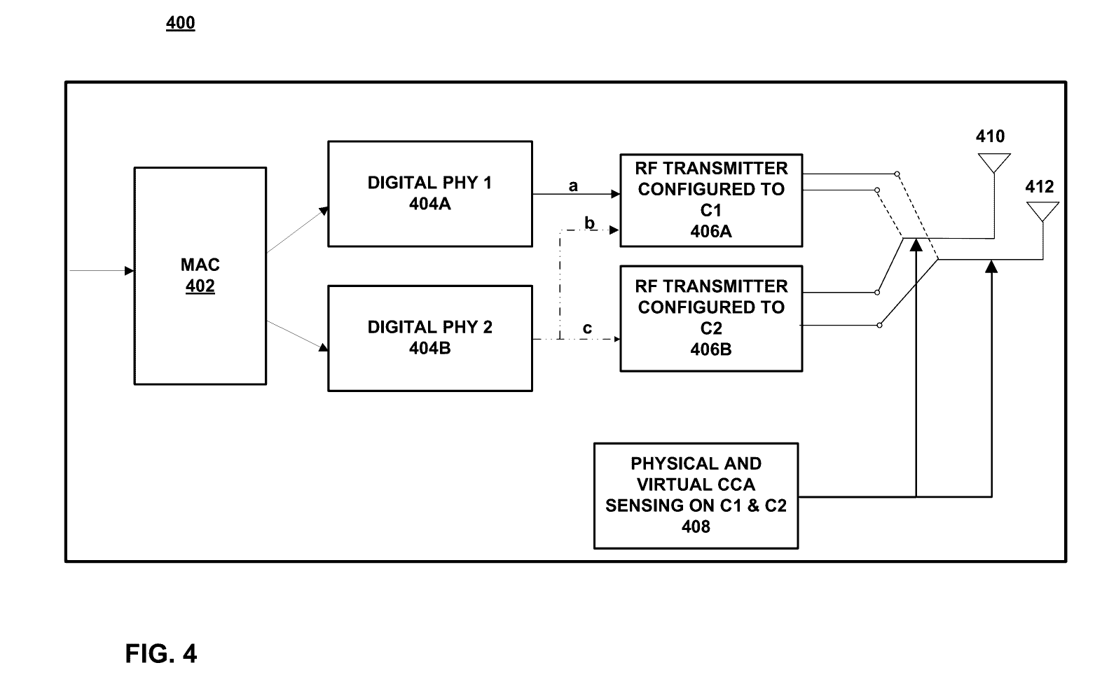

FIG. 4 shows an example of a device configured to transmit data across two or more channels according to the same standard in accordance with the techniques of this disclosure. Device 400 may, for example, correspond to device 210 and/or device 250 described above with respect to FIG. 2. Device 400 may be configured to process, during a communication session, a first data packet and a second data packet, and during the communication session, transmitting the first data packet on a first wireless communication channel and, during the communication session, transmit the second data packet from the device on a second wireless communication channel.

Device 400 includes MAC data communication control module 402, first digital physical layer hardware 404A, second digital physical layer hardware 404B, an RF transmitter configured to channel 1 406A, an RF transmitter configured to channel 2 406B, physical and virtual CCA sensing module 408, antenna 410 and antenna 412.

In FIG. 3, MAC 302 implements two standards. In FIG. 4, MAC 402 only implements one standard. MAC 402 is configured to generate and assemble datagrams according to that standard. The one standard implemented by MAC 402 may, for example, be any one of the various standards discussed above.

Digital PHY 1 404A, in conjunction with RF transmitter 406A, converts the data packets produced by MAC 402 into a physical signal with the physical characteristics of the standard being implemented by MAC 402 for communication over channel 1. Similarly, in some implementations digital PHY 2 404B, in conjunction with RF transmitter 406B, converts the data packets produced by MAC 402 into a physical signal with different physical characteristics defined in the standard supported by MAC 402 for communication over channel 2. For example, if MAC 402 implements the 802.11n standard, digital PHY 1 and RF transmitter 406A may be configured to generate a 2.4 GHz signal, while digital PHY 2 may be configured to generate a 5 GHz signal. In this implementation, despite MAC 402 only implementing one standard, digital PHYs 404A and 404B and RF transmitters 406A and 406B may still implement two different modulation and coding scheme and utilize two different bandwidths for transmission. In this implementation, digital PHY 1 may supply data to RF transmitter 406 A via path “a,” and digital PHY 2 may supply data to RF transmitter 406B via path “c” shown in FIG. 4.

In the example of FIG. 4, device 400 includes two separate data paths, which will generally be referred to as the channel 1 path (e.g. MAC 402, digital PHY 1 404A, and RF transmitter 406A) and the channel 2 path (e.g. MAC 302, digital PHY 2 404B, and RF transmitter 406B). Both data paths utilize antenna 410 and antenna 412 for data transmission. As with device 300 described above, device 400 may, for example, use multiple antennas for purposes such as beamforming and multiplexing in order to improve signal quality and increase bandwidth.

CCA engine 408 senses the conditions on the two corresponding channels. CCA engine 408 generally functions in the same manner as CCA engine 308 described above. As part of performing physical sensing, CCA engine 408 may, for example, measure signal strength and/or energy (e.g. RSSI) to determine if a channel is busy. As part of performing virtual sensing, CCA engine 408 may, for example, monitor channels 1 and 2 for decoded control packets sent by other users on the channel to indicate if the channel is reserved for a duration of time.

If the physical sensing of CCA engine 408 indicates that the channel is not busy, and the virtual sensing of CCA engine 408 also indicates that the channel is not being reserved, then device 400 may select that channel to transmit a packet, with the physical signal being formatted according to the selected channel. CCA engine 408 may be configured to select a channel based on one or more criteria, such as selecting the channel that produces the highest throughput, selecting the channel the uses minimal power, selecting the channel that gives the lowest latency, or some combination of these criteria.

In some implementations, device 400 may be configured to simultaneously process packets for both channel 1 and channel 2, and then upon CCA engine 408 selecting a channel, only transmit, via one or both of antennas 410 and 412, the packet corresponding to the selected channel. In such an implementation, RF transmitters 406A and 406B may include buffers for holding packets while awaiting transmission. Upon CCA engine 408 selecting a channel, the RF transmitter of the selected channel may retrieve the packet from the buffer and transmit the packet, while the RF transmitter of the non-selected channel may flush the packet from the buffer.

In some implementations, MAC 402 may implements one standard using the same band but different PHY parameters. As one example, MAC 402 may be configured to generate 802.11n packets for transmission using two different bandwidths, such as 20 MHz and 40 MHz on the 5 GHz band. In such an implementation, the data transmission may occur on the same channel but be processed using different paths. In such an implementation, upon CCA engine 408 may select a data path based on one or more criteria, such as selecting the data path that produces the highest throughput, selecting the data path the uses minimal power, selecting the data path that gives the lowest latency, or some combination of these criteria.

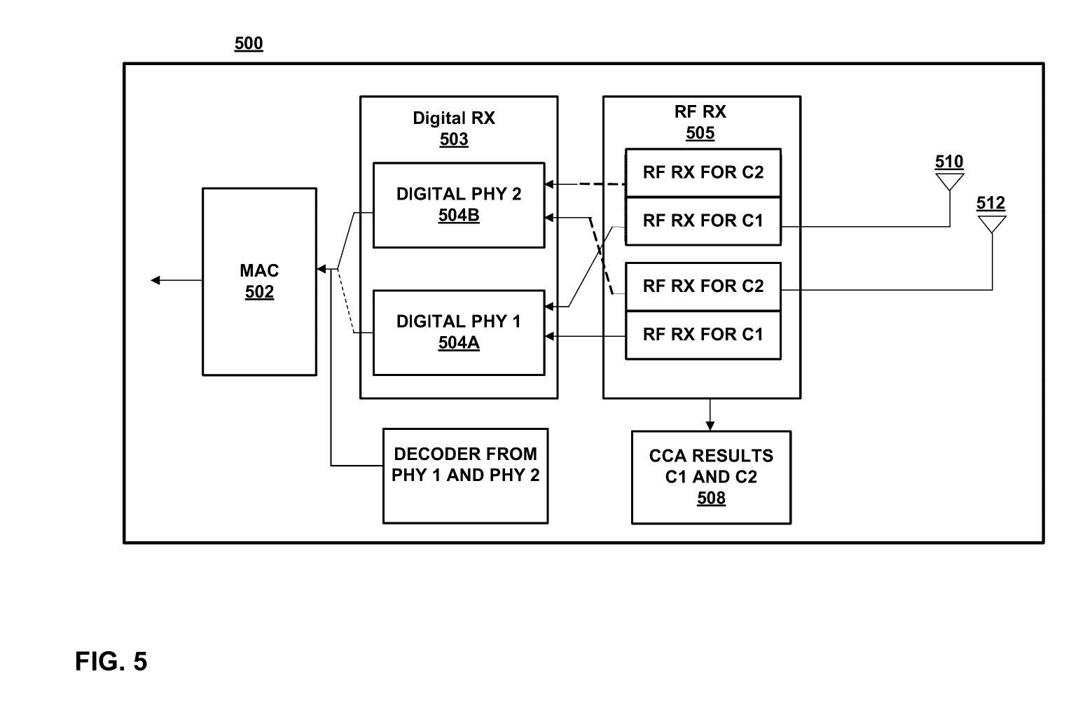

FIG. 5 shows an example of a device configured to receive data across two or more channels in accordance with the techniques of this disclosure. Device 500 may, for example, correspond to device 210 and/or device 250 described above with respect to FIG. 2. Device 500 includes MAC data communication control module 502 (MAC 502), digital receiving hardware 503, RF receiver 505, antenna 510 and antenna 512. Digital receiving hardware includes digital PHY 1 504A and digital PHY 2 504B. RF receiver 505 includes hardware for receiving

Device 500 may receive data across two channels according to different standards or according to a single standard. Device 500 may receive data on channels C1 or C2 (Channels belonging to the same or different bands). Also, data may belong to one or two different standards, e.g. two different 802.11 standard amendments. Device 500 may perform simultaneous RF monitoring of channels C1 and C2. Digital PHY 504A and digital PHY 504B may be configured for different standard amendments with different PHY parameters. MAC Configurations for the standard used by the “successful” digital PHY may be activated.

Device 500 may also receive data across two channels according to the same standard. In such instances, device 500 may receive data on channels C1 or C2 (Channels belonging to the same or different bands). Device 500 may perform simultaneous RF monitoring of channels C1 and C2. The same standard amendment may be assumed even when multiple Digital PHYs are activated. One MAC layer pertaining to the negotiated connection between devices may be used for decoding.

CCA engine 508 simultaneously monitors all channels of RF RX 505. If CCA engine 508 detects a valid signal on one of the channels, then CCA engine 508 enables the one of digital PHY 1 504A or digital PHY 2 504B that corresponds to the channel with the detected signal. In the case where two channels shows the possibility of valid packets, then CCA engine 508 may enable both digital PHY 1 504A and digital PHY 2 504B. The output of digital receiver 503 may include an indication of which digital PHY was used. The successful decoded PHY packet from the “passing” Digital PHY would be sent to the MAC layer for processing based on the standard used by the “passing” Digital PHY. After MAC 502 processes the received packet, a reordering entity (not shown in FIG. 5) may reorder packets coming from MAC 502 due to the transmission using different standards potentially resulting in the packets being received out of order. The reordering entity may, for example, reorder the packets based on a packet number, such as a value of the 802.11 MAC header sequence number field, which is a 12-bit field that indicates the sequence number of an MSDU (MAC Service Data Unit), A-MSDU (Aggregated-MSDU), or MMPDU (Management MAC Protocol Data Unit). The sequence number is assigned from a single modulo-4096 counter, starting at 0 and incrementing by 1.

Also, although FIGS. 3-5 show two separate data paths used for RX and TX processing, the techniques of this disclosure may be implemented in devices or systems that utilize more than two data paths. Additionally, for purposes of explanation, FIGS. 3-5 separate out aspects of transmitting and receiving data according to the techniques of this disclosure. It should be understood, however, that devices such as devices 210 and 250 may be configured to both transmit and receive, and moreover, may be configured to transmit in multiple modes and/or receive in multiple modes. Accordingly, the techniques described with respect to FIGS. 3-5 of this disclosure may be used jointly in a single device.

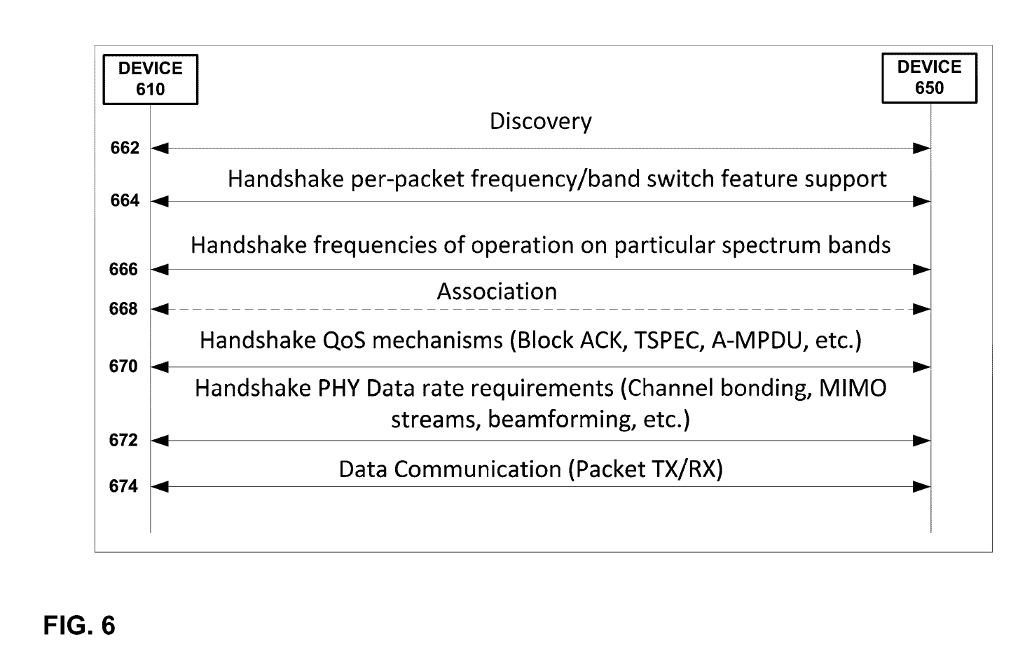

FIG. 6 shows an example operation sequence performed by two devices configured to implement the techniques of this disclosure. Devices 610 and 650 are examples of devices configured to transmit and receive, during a communication session, data packets on a first wireless communication channel, and during the same communication session, also transmit and receive data packets on a second wireless communication channel. Prior to transmitting and receiving on two wireless communication channels, devices 610 and 650 may perform session negotiation to associate and exchange capability information. FIG. 6 shows an example of such a session negotiation. Some techniques require ending one communication session and establishing a new communication session, with each communication session needing its own session negotiation in order to change the frequency or band being used for communication. However, the techniques of this disclosure may enable per-packet band switching and per-packet frequency switching in a single communication session that is established with a single session negotiation.

In the example of FIG. 6, devices 610 and 650 may perform capability verification and capability negotiation, as shown in FIG. 6, prior to communicating across multiple channels. As part of a discovery process (662), devices 610 and 650 may, for example, each broadcast their availability and capabilities. Device 610 and 650 may, for example, broadcast if they support per-packet frequency/band switching. If both device 610 and 650 support per-packet frequency/band switching, then devices 610 and 640 may handshake to enable such feature (664). After enabling a per-packet frequency/band switching feature, devices 610 and 640 may negotiate which frequencies/bands to use (666). After agreeing to which frequencies/bands to use, devices 610 and 640 may, for example, perform an association process (668), such as the 802.11 association process where devices establish an authenticated and associated connection state.

After being associated, devices 610 and 640 may exchange MAC layer capabilities (670), such as quality of service (QoS) mechanisms such as block acknowledgement, traffic specification (TSPEC), aggregated MAC protocol Data unit (A-MPDU), and others. Devices 610 and 640 may exchange MAC layer capabilities for each channel, with different channels not necessarily having the same capabilities. Devices 610 and 640 may, for example, performing session negotiation by exchanging first MAC layer capability information and second MAC layer capability information, with the first MAC layer capability information including MAC layer capability information for the first wireless communication channel, and with the second MAC layer capability information including second MAC layer capability information for the second wireless communication channel.

Devices 610 and 640 may also exchange physical layer capabilities (672), such as data rate requirements including channel bonding, MIMO streams, beamforming, and others, with each channel not necessarily having the same physical layer capabilities. Devices 610 and 640 may, for example, perform session negotiation by exchanging first physical layer capability information and second physical layer capability information, with the first physical layer capability information including physical layer capability information for the first wireless communication channel and the second physical layer capability information including physical layer capability information for the second wireless communication channel.

After exchanging MAC layer capabilities and physical layer capabilities, devices 610 and 640 may begin data communication (674) that includes per-packet frequency switching and/or per-packet band switching.

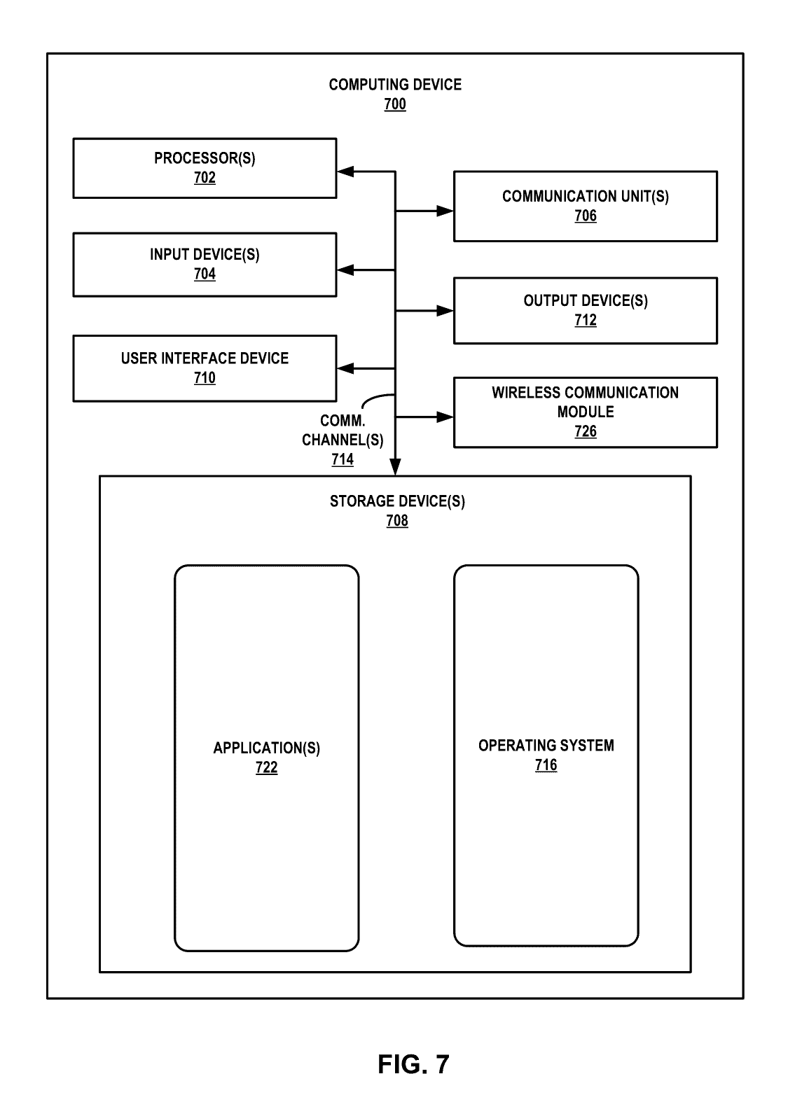

FIG. 7 is a block diagram illustrating an example instance of a computing device 700 operating according to techniques described in this disclosure. FIG. 7 illustrates only one particular example of computing device 700, and other examples of computing device 700 may be used in other instances. Although shown in FIG. 7 as a stand-alone computing device 700 for purposes of example, a computing device may be any component or system that includes one or more processors or other suitable computing environment for executing software instructions and, for example, need not necessarily include one or more elements shown in FIG. 7 (e.g., input devices 704, user interface devices 710, output devices 712).

As shown in the specific example of FIG. 7, computing device 700 includes one or more processors 702, one or more input devices 704, one or more communication units 706, one or more output devices 712, one or more storage devices 708, and user interface (UI) device 710, and wireless communication module 726. Computing device 700, in one example, further includes one or more applications 722 and operating system 716 that are executable by computing device 700. Each of components 702, 704, 706, 708, 710, 712, and 726 are coupled (physically, communicatively, and/or operatively) for inter-component communications. In some examples, communication channels 714 may include a system bus, a network connection, an inter-process communication data structure, or any other method for communicating data. As one example in FIG. 7, components 702, 704, 706, 708, 710, 712, and 726 may be coupled by one or more communication channels 714. One or more applications 722 may also communicate information with one another as well as with other components in computing device 700.

Processors 702, in some examples, are configured to implement functionality and/or process instructions for execution within computing device 700. For example, processors 702 may be capable of processing instructions stored in storage device 708. Examples of processors 702 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 708 may be configured to store information within computing device 700 during operation. Storage device 708, in some examples, is described as a computer-readable storage medium. In some examples, storage device 708 is a temporary memory, meaning that a primary purpose of storage device 708 is not long-term storage. Storage device 708, in some examples, is described as a volatile memory, meaning that storage device 708 does not maintain stored contents when the computer is turned off. Examples of volatile memories include random access memories (RAM), dynamic random access memories (DRAM), static random access memories (SRAM), and other forms of volatile memories known in the art. In some examples, storage device 708 is used to store program instructions for execution by processors 702. Storage device 708, in one example, is used by software or applications running on computing device 700 to temporarily store information during program execution.

Storage devices 708, in some examples, also include one or more computer-readable storage media. Storage devices 708 may be configured to store larger amounts of information than volatile memory. Storage devices 708 may further be configured for long-term storage of information. In some examples, storage devices 708 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 700, in some examples, also includes one or more communication units 706. Computing device 700, in one example, utilizes communication unit 706 to communicate with external devices via one or more networks, such as one or more wireless networks. Communication unit 706 may be a network interface card, such as an Ethernet card, an optical transceiver, a radio frequency transceiver, or any other type of device that can send and receive information. Other examples of such network interfaces may include Bluetooth, 4G and Wi-Fi radios computing devices as well as Universal Serial Bus (USB). In some examples, computing device 700 utilizes communication unit 706 to wirelessly communicate with an external device such as a server.

In addition, the computing device 700 may include wireless communication module 726. As described herein, wireless communication module 726 may be active hardware that is configured to communicate with other wireless communication devices. These wireless communication devices may operate according to Bluetooth, Ultra-Wideband radio, Wi-Fi, or other similar protocols. In some examples, wireless communication module 726 may be an external hardware module that is coupled with computing device 700 via a bus (such as via a Universal Serial Bus (USB) port). Wireless communication module 726, in some examples, may also include software which may, in some examples, be independent from operating system 716, and which may, in some other examples, be a sub-routine of operating system 716.

Computing device 700, in one example, also includes one or more input devices 704. Input device 704, in some examples, is configured to receive input from a user through tactile, audio, or video feedback. Examples of input device 704 include a presence-sensitive display, a mouse, a keyboard, a voice responsive system, video camera, microphone or any other type of device for detecting a command from a user.

One or more output devices 712 may also be included in computing device 700. Output device 712, in some examples, is configured to provide output to a user using tactile, audio, or video stimuli. Output device 712, in one example, includes a presence-sensitive display, a sound card, a video graphics adapter card, or any other type of device for converting a signal into an appropriate form understandable to humans or machines. Additional examples of output device 712 include a speaker, a cathode ray tube (CRT) monitor, a liquid crystal display (LCD), or any other type of device that can generate intelligible output to a user. In some examples, user interface (UI) device 710 may include functionality of input device 704 and/or output device 712.

Computing device 700 may include operating system 716. Operating system 716, in some examples, controls the operation of components of computing device 700. For example, operating system 716, in one example, facilitates the communication of applications 722 with processors 702, communication unit 706, storage device 708, input device 704, user interface device 710, wireless communication module 726, and output device 712. Applications 722 may also include program instructions and/or data that are executable by computing device 700. As one example, applications 722 may include instructions that cause computing device 700 to perform one or more of the operations and actions described in the present disclosure.

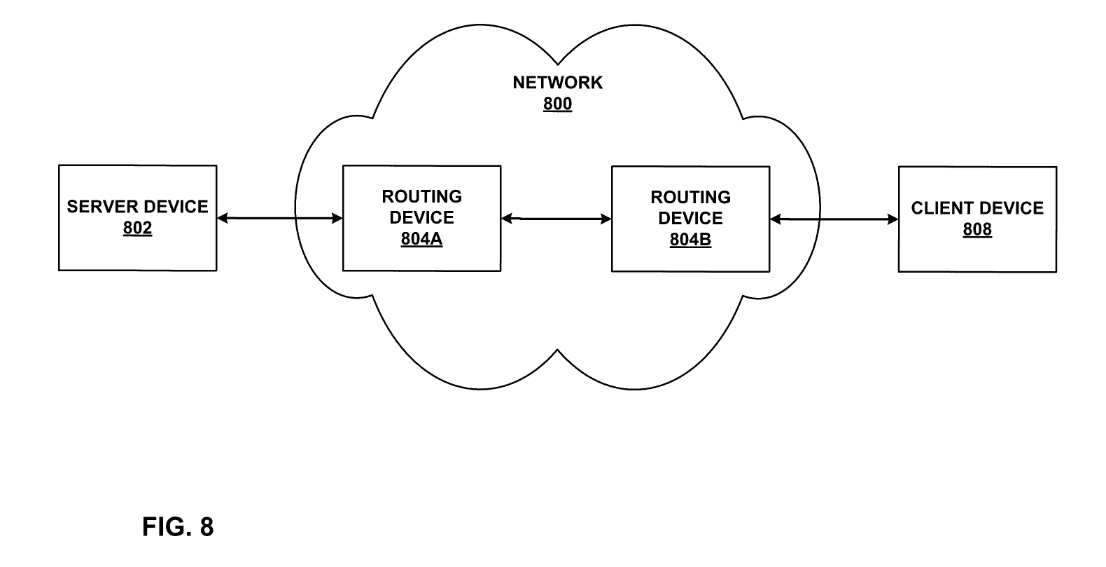

FIG. 8 is a block diagram illustrating an example set of devices that form part of network 800. In this example, network 800 includes routing devices 804A, 804B (routing devices 804). Routing devices 804 are intended to represent a small number of devices that may form part of network 800. Other network devices, such as switches, hubs, gateways, firewalls, bridges, and other such devices may also be included within network 800. Moreover, additional network devices may be provided along a network path between server device 802 and client device 808.

In general, routing devices 804 implement one or more routing protocols to exchange network data through network 800. In some examples, routing devices 804 may be configured to perform proxy or cache operations. Therefore, in some examples, routing devices 804 may be referred to as proxy devices. In general, routing devices 804 execute routing protocols to discover routes through network 800. By executing such routing protocols, routing device 804B may, for example, discover a network route from itself to server device 802 via routing device 804A. Server device 802, routing devices 804, and client device 808 are examples of devices that may implement techniques described in this disclosure. For example, although not shown in FIG. 8, server device 802 and/or client device 808 may be wirelessly communicatively coupled to respective wireless access points between routers 804A, 804B, respectively.

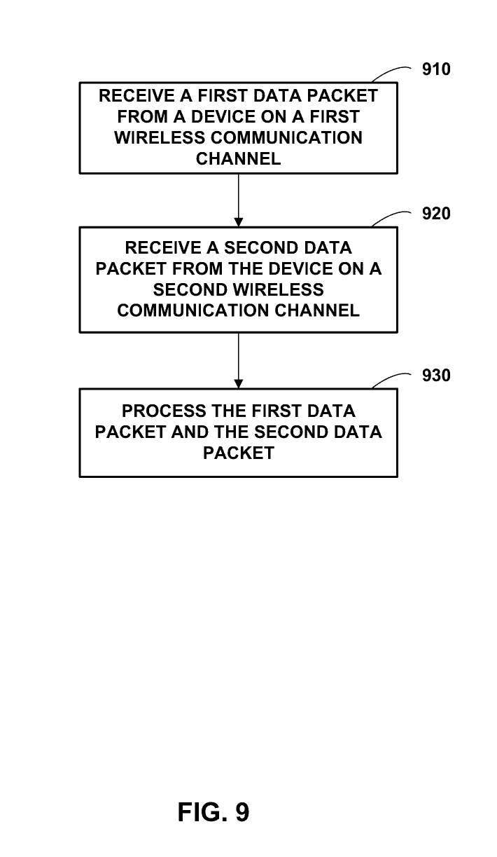

FIG. 9 is a flowchart showing an example method of transmitting data according to the techniques of this disclosure. The techniques of FIG. 9 will be described with respect to a generic receiving device. The generic receiving device may, for example, correspond to any of devices 210, 250, 500, 610, 650, or to other devices described in this disclosure. The receiving device receives a first data packet from a device on a first wireless communication channel (910). The receiving device receives a second data packet from the device on a second wireless communication channel (920). The receiving device processes the first data packet and the second data packet (930).

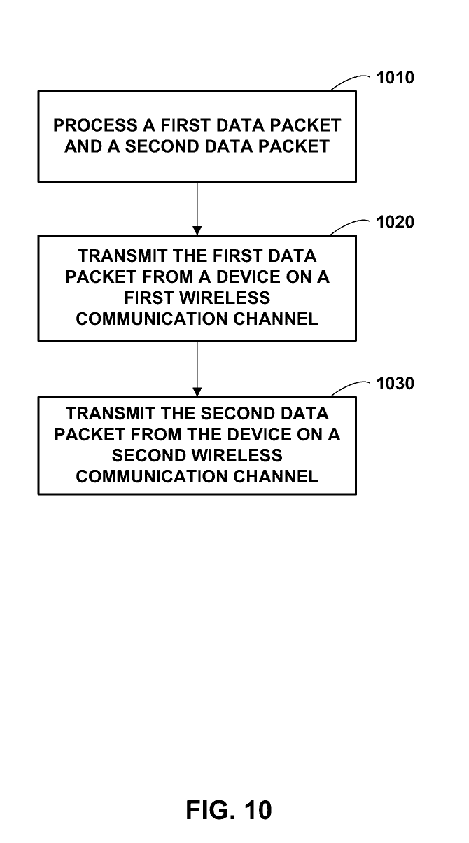

FIG. 10 is a flowchart showing an example method of receiving data according to the techniques of this disclosure. The techniques of FIG. 9 will be described with respect to a generic transmitting device. The generic transmitting device may, for example, correspond to any of devices 210, 250, 300, 400, 610, 650, or to other devices described in this disclosure. The transmitting device processes a first data packet and a second data packet (1010). The device transmits the first data packet from a device on a first wireless communication channel (1020). The device transmits the second data packet from the device on a second wireless communication channel (1030).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method for receiving data, the method comprising:
during a communication session, receiving a first data packet from a device on a first wireless communication channel;
during the communication session, receiving a second data packet from the device on the second wireless communication channel; and
processing the first data packet and the second data packet.

2. The method of claim 1, further comprising:
simultaneously monitoring the first wireless communication channel and the second wireless communication channel for receiving the first data packet and the second data packet.

3. The method of claim 1, further comprising:
performing session negotiation with the device to establish the communication session.

4. The method of claim 3, wherein performing session negotiation comprises exchanging first media access control (MAC) layer capability information and second MAC layer capability information with the device, wherein the first MAC layer capability information comprises MAC layer capability information for the first wireless communication channel, and wherein the second MAC layer capability information comprises second MAC layer capability information for the second wireless communication channel.

5. The method of claim 3, wherein performing session negotiation comprises exchanging first physical layer capability information and second physical layer capability information with the device, wherein the first physical layer capability information comprises physical layer capability information for the first wireless communication channel, and wherein the second physical layer capability information comprises physical layer capability information for the second wireless communication channel.

6. The method of claim 1, further comprising:
associating with the device to establish the communication session.

7. The method of claim 1, wherein the first communication channel and the second communication channel are defined by a common wireless communication standard.

8. The method of claim 1, wherein the first communication channel and the second communication channel are defined by different wireless communication standards.

9. The method of claim 1, wherein a carrier frequency of the first wireless communication channel is different than a carrier frequency of the second wireless communication channel.

10. The method of claim 1, wherein a modulation scheme of the first wireless communication channel is different than a modulation scheme of the second wireless communication channel.

11. A method for transmitting data, the method comprising:
during a communication session, processing a first data packet and a second data packet;
during the communication session, transmitting, with a device, the first data packet on a first wireless communication channel; and
during the communication session, transmitting, with the device, the second data packet on a second wireless communication channel.

12. The method of claim 11, further comprising:
during the communication session, processing a third data packet;
measuring a physical property of the first wireless communication channel;
measuring a physical property of the second wireless communication channel;
based on the measured physical property of the first wireless communication channel and the measured physical property of the second wireless communication channel, determining one of the first wireless communication channel and the second wireless communication channel for transmitting the third data packet.

13. The method of claim 11, further comprising:
during the communication session, processing a third data packet;
monitoring the first wireless communication channel for a first control packet to reserve the first wireless communication channel;
monitoring the second wireless communication channel for a second control packet to reserve the second wireless communication channel;
in response to detecting the first control packet to reserve the first wireless communication channel, selecting the second wireless communication channel for transmitting the third data packet.

14. The method of claim 11, further comprising:
performing session negotiation with a receiving device to establish the communication session.

15. The method of claim 14, wherein performing session negotiation comprises exchanging first MAC layer capability information and second MAC layer capability information with the receiving device, wherein the first MAC layer capability information comprises MAC layer capability information for the first wireless communication channel, and wherein the second MAC layer capability information comprises second MAC layer capability information for the second wireless communication channel.

16. The method of claim 14, wherein performing session negotiation comprises exchanging first physical layer capability information and second physical layer capability information with the receiving device, wherein the first physical layer capability information comprises physical layer capability information for the first wireless communication channel, and wherein the second physical layer capability information comprises physical layer capability information for the second wireless communication channel.

17. The method of claim 11, further comprising:
associating with a receiving device to establish the communication session.

18. The method of claim 11, wherein the first communication channel and the second communication channel are defined by a common wireless communication standard.

19. The method of claim 11, wherein the first communication channel and the second communication channel are defined by different wireless communication standards.

20. The method of claim 11, wherein a carrier frequency of the first wireless communication channel is different than a carrier frequency of the second wireless communication channel.

21. The method of claim 11, wherein a modulation scheme of the first wireless communication channel is different than a modulation scheme of the second wireless communication channel.

22. A device for receiving data, the device comprising:
a receiver configured to:
during a communication session, receive a first data packet from a device on a first wireless communication channel;
during the communication session, receive a second data packet from the device on the second wireless communication channel; and
one or more processors configured to process the first data packet and the second data packet.

23. The device of claim 22, wherein the one or more processors are further configured to simultaneously monitor the first wireless communication channel and the second wireless communication channel.

24. The device of claim 22, wherein the one or more processors are further configured to perform session negotiation with the device to establish the communication session.

25. The device of claim 24, wherein to perform session negotiation, the one or more processors are configured to received first MAC layer capability information and second MAC layer capability information with the device, wherein the first MAC layer capability information comprises MAC layer capability information for the first wireless communication channel, and wherein the second MAC layer capability information comprises second MAC layer capability information for the second wireless communication channel.

26. The device of claim 24, wherein to perform session negotiation, the one or more processors are configured to receive first physical layer capability information and second physical layer capability information with the device, wherein the first physical layer capability information comprises physical layer capability information for the first wireless communication channel, and wherein the second physical layer capability information comprises physical layer capability information for the second wireless communication channel.

27. A device for transmitting data, the device comprising:
one or more processors configured to process a first data packet and a second data packet;
a transmitter configured to:
during a communication session, transmit the first data packet from a device on a first wireless communication channel; and
during the communication session, transmit the second data packet from the device on a second wireless communication channel.

28. The device of claim 27, wherein the one or more processors are further configured to:
during the communication session, process a third data packet;
measure a physical property of the first wireless communication channel;
measure a physical property of the second wireless communication channel;
based on the measured physical property of the first wireless communication channel and the measured physical property of the second wireless communication channel, determine one of the first wireless communication channel and the second wireless communication channel for transmitting the third data packet.

29. The device of claim 27, wherein the one or more processors are further configured to:
during the communication session, process a third data packet;
monitor the first wireless communication channel for a control packet to reserve the first wireless communication channel;
monitor the second wireless communication channel for a control packet to reserve the second wireless communication channel;
in response to detecting a control packet to reserve the first wireless communication channel, select the second wireless communication channel for transmitting the third data packet.
